(19) United States
(12) Patent Application Publication
(10) Pub. No.: US 2007/0188594 A1
(43) Pub. Date: Aug. 16, 2007

(54) Communication system, communication terminal and communication method

(75) Inventor: Tatsuo Yoshino, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/700,047

(22) Filed: Jan. 31, 2007

(30) Foreign Application Priority Data
Jan. 31, 2006 (JP) 2006-022963

(51) Int. Cl. H04N 7/14

(52) U.S. Cl. 348/14.1

(57) ABSTRACT

A communication system comprising:

a sender terminal which sends a subject video and video contents, and

a receiver terminal which receives the subject video and the video contents from the sender terminal and displays the subject video and the video contents on a screen, wherein

the receiver terminal comprises a receiver operation unit which accepts various input operations related to the video contents displayed on the screen, and an operation identifying signal sending unit which sends an operation identifying signal that is a signal for identifying an operation related to the video contents which has been inputted to the receiver operation unit, to the sender terminal; and

the sender terminal comprises an operation identifying signal receiving unit which receives the operation identifying signal, and a sender operation unit which identifies the operation related to the video contents in the receiver terminal according to the operation identifying signal received by the operation identifying signal receiving unit and regards the identified operation in the receiver terminal as the input operation.

### BACKGROUND OF THE INVENTION

1. Field of the Invention

The present invention relates to a communication system, a communication terminal and a communication method, and more particularly relates to a system, a terminal and a method which provide two-way communication via images or audios.

2. Description of the Related Art

Conventionally, a technique for causing contents being viewed at one terminal to be similarly displayed also at another desired terminal has been developed. For example, according to Japanese Patent Application Laid-Open No. 2003-122694, a browser having a proxy server including a proxy module and a browser module capable of receiving a content cache update event from the proxy module is set to each of an operator's computer operated by a sales operation support person as a specialist and an agent's computer operated by a sales person located remotely from the operator's computer, and both virtual browsers are synchronized with each other. The computers set as described above are permitted to be updated and connected on a network, and a Web server for obtaining update information is connected to the operator's computer to configure an information duplicating system, wherein information on a browsing target such as a Web page obtained by the operator's computer or the like is automatically duplicated to be displayed at the agent's computer.

Incidentally, if terminals connected to one another via a communication network communicate multiple videos with one another in real time as shown in a videophone system and a video conference system, it would be convenient if previously prepared still images or moving images could be selected as one of the videos to be sent from a user's own terminal to a partner's terminal.

In the technique of Japanese Patent Application Laid-Open No. 2003-122694, the browsing target duplicated by the operator's computer is merely displayed at the agent's computer, and interactivity in which a desired video is sent to and received from both of the user's own terminal and the partner's terminal has not been suggested at all.

Also in the technique of Japanese Patent Application Laid-Open No. 2003-122694, a browsing screen of the operator's computer is merely duplicated at the agent's computer, and it is unclear whether the browsing target can be freely operated by the agent's computer, and if the browsing target can be operated by the agent's computer, it is also unclear how the operation is handled by the operator's computer.

### SUMMARY OF THE INVENTION

It is an object of the present invention to provide a communication system which sends and receives videos in real time, wherein a user can send an arbitrary video being browsed by the user to a partner and the partner can also perform an operation related to the video.

In order to solve the above described problems, the present invention provides a communication system including a sender terminal which sends a subject video and video contents, and a receiver terminal which receives the subject video and the video contents from the sender terminal and displays the subject video and the video contents on a screen, wherein the receiver terminal includes a receiver operation unit which accepts various input operations related to the video contents displayed on the screen, and an operation identifying signal sending unit which sends an operation identifying signal that is a signal for identifying an operation related to the video contents which has been inputted to the receiver operation unit, to the sender terminal, and the sender terminal includes an operation identifying signal receiving unit which receives the operation identifying signal, and a sender operation unit which identifies the operation related to the video contents in the receiver terminal according to the operation identifying signal received by the operation identifying signal receiving unit and regards the identified operation in the receiver terminal as the input operation.

According to the present invention, the receiver terminal, which receives the video contents inputted by various video content input systems from the sender terminal, sends the signal for identifying the operation related to the video contents to the sender terminal. Based on the signal, the sender terminal regards the input operation performed in the receiver terminal as its own input operation. This enables a user of the receiver terminal to perform remote operations with respect to the video contents inputted to the sender terminal while viewing a partner's subject video, video contents and audios sent from the sender terminal.

Particularly, a receiver terminal or a sender terminal newly provided by combining configurations of the receiver terminal and the sender terminal enables the user to remotely input the operation related to the video contents which is inputted to the partner's terminal, from the user's own terminal, while interacting with the partner via the videos and the audios sent to and received from the partner.

Here, the receiver terminal may synthesize the received video contents and a video showing the input operation related to the video contents which has been accepted by the receiver operation unit, and display the synthesized video contents and the video.

This enables visualization of the input operation performed with respect to the video contents in the receiver terminal, at the receiver terminal.

In addition, the sender terminal may display a list of one or more video content input systems on the screen, and send the video contents of the input system arbitrarily specified from the list of the video content input systems displayed on the screen according to the input operation with respect to the sender operation unit, to the receiver terminal.

Here, the one or more video content input systems may illustratively include a content server, a Web server, an information reading device for a portable recording medium, a still camera, a video camera, or a combination of some or all of the content server, the Web server, the information reading device for the portable recording medium, the still camera and the video camera.

Examples of the various input operations related to the video contents may include specifying an image for which a print is ordered, specifying a video to be played, and requesting to download original data of video content data.

The present invention is a communication terminal which sends a subject video and video contents to a partner's communication terminal, including an operation identifying signal receiving unit which receives an operation identifying signal that is a signal for identifying an operation related to the video contents which has been inputted to the partner's communication terminal, from the partner's communication terminal, and a sender operation unit which identifies the operation related to the video contents in the partner's communication terminal according to the operation identifying signal received by the operation identifying signal receiving unit and regards the identified operation in the partner's communication terminal as an input operation.

In addition, the present invention is a communication terminal which receives a subject video and video contents from a partner's communication terminal and displays the subject video and the video contents on a screen, including an operation identifying signal sending unit which sends an operation identifying signal that is a signal for identifying an operation related to the video contents displayed on the screen, to the partner's communication terminal.

The present invention relates to a communication method used in a communication system including a sender terminal which sends a subject video and video contents, and a receiver terminal which receives the subject video and the video contents from the sender terminal and displays the subject video and the video contents on a screen. This method includes the steps of accepting an input operation related to the video contents displayed on the screen of the receiver terminal, sending an operation identifying signal that is a signal for identifying the accepted operation related to the video contents, receiving the operation identifying signal, and identifying the operation related to the video contents in the receiver terminal according to the received operation identifying signal and regarding the identified operation in the receiver terminal as the input operation in the sender terminal.

According to the present invention, the receiver terminal, which receives the video contents inputted by the various video content input systems from the sender terminal, sends the signal for identifying the operation related to the video contents to the sender terminal. Based on the signal, the sender terminal regards the input operation performed in the receiver terminal as its own input operation. This enables the user of the receiver terminal to perform the remote operations with respect to the video contents inputted to the sender terminal while viewing the partner's subject video, video contents and audios sent from the sender terminal.

Particularly, a receiver terminal or a sender terminal newly provided by combining configurations of the receiver terminal and the sender terminal enables the user to remotely input the operation related to the video contents which is inputted to the partner's terminal, from the user's own terminal, while interacting with the partner via the videos and the audios sent to and received from the partner.

### BRIEF DESCRIPTION OF THE DRAWINGS

FIG. 1 is a block diagram of a video and audio communication system according to the first embodiment;

FIG. 2 is a block diagram of a communication terminal;

FIG. 3 shows an example of a screen displayed on a monitor 5;

FIG. 4 conceptually illustrates a full screen user's own video display mode;

FIG. 5 conceptually illustrates a full screen partner's video display mode;

FIG. 6 conceptually illustrates a PoutP screen (normal dialog) display mode;

FIG. 7 conceptually illustrates a PoutP screen (contents dialog (1)) display mode;

FIG. 8 conceptually illustrates a PoutP screen (contents dialog (2)) display mode;

FIG. 9 conceptually illustrates a full screen (contents dialog (3)) display mode;

FIG. 10 conceptually illustrates tiles delimiting display areas;

FIG. 11 is a detailed block diagram of a coding unit;

FIG. 12 is a flowchart showing operations of communication terminals;

FIG. 13 shows a state where “Still”, that is, a digital still camera has been selected as a content video input source;

FIG. 14 shows a state where a stream moving image of a selected still image is displayed as video contents and a subject imaged by a partner's camera is also displayed;

FIG. 15 shows a state where “DV”, that is, a digital video camera has been selected as the content video input source;

FIG. 16 shows a state where a stream moving image of a selected moving image is displayed as the video contents and the subject imaged by the partner's camera is also displayed;

FIG. 17 shows a state where “Content Server”, that is, a streaming server has been selected as the content video input source;

FIG. 18 shows a state where the selected moving image is displayed as the video contents and the subject imaged by the partner's camera is also displayed;

FIG. 19 shows a state where “Web Server”, that is, a Web content server has been selected as the content video input source;

FIG. 20 shows a state where selected Web contents are displayed as the video contents and the subject imaged by the partner's camera is also displayed; and

FIG. 21 shows a state where a video showing an operation inputted by a user's own remote control and the like is synthesized with a video received from the partner's communication terminal, and displayed.

### DETAILED DESCRIPTION OF THE PREFERRED EMBODIMENTS

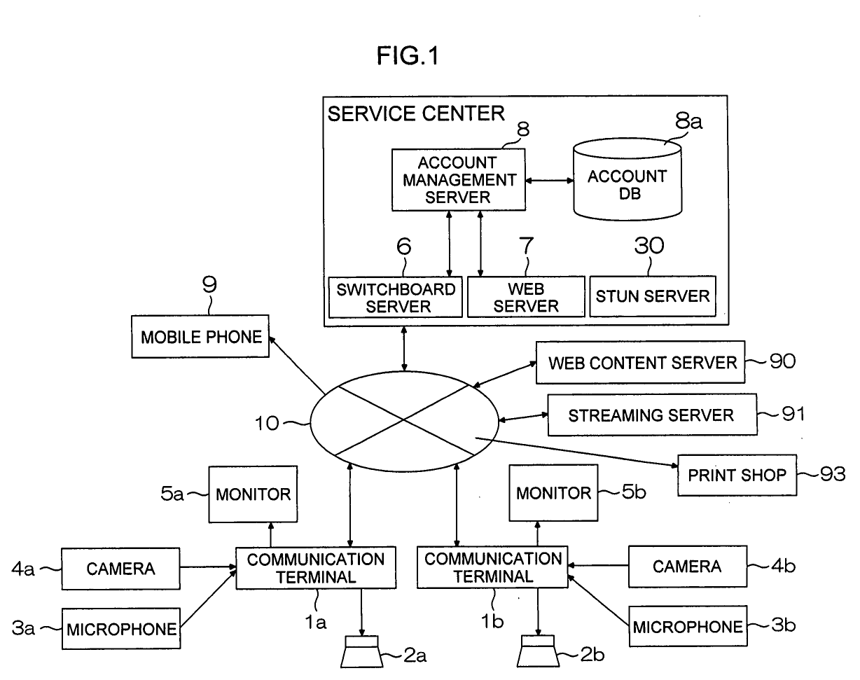

FIG. 1 is a block diagram of a video and audio communication system according to a preferred embodiment of the present invention. In this system, a communication terminal 1a and a communication terminal 1b having equal configurations are connected via a network 10 such as the Internet, and videos and audios are sent to and received from each other.

It should be noted that since the communication terminal 1a and the communication terminal 1b have similar configurations and are distinguished from each other only for distinguishing communication partners in the network, all or some of both roles are interchangeable in the following description. Both may be collectively represented as the communication terminal 1, if there is no need to distinguish them as the communication partners in the network.

The network 10 is configured with, for example, a broadband network such as ADSL, an optical fiber (FTTH) and a cable television, a narrowband network such as ISDN, IEEE 802.xx compliant wireless communication such as UWB (Ultra Wide Band) or Wi-Fi (Wireless Fidelity) and the like.

In this embodiment, the network 10 is assumed to be a best-effort type network not ensuring whether or not a band (communication speed) of a predetermined value can be constantly obtained. In the network 10, its nominal maximum band may be substantially limited due to various factors including a distance between a telephone office and a user's home, a communication speed between ADSL modems, increase and decrease in traffic, a communication environment of a session partner, and the like. Its actual value may even frequently become less than or equal to a fraction of its nominal value. The band of the network 10 is represented in bit per second (bps). For example, a nominal band of FTTH is typically 100 Mbps and the like, which, however, may be practically limited to several hundred kbps.

A connection route between the communication terminal 1a and the communication terminal 1b is specified by a switchboard server 6 configured with a SIP (Session Initiation Protocol) server, by using a network address (global IP address and the like), a port and an identifier (MAC address and the like). Information related to a user of the communication terminal 1, such as a name, an email address and the like, and information related to the connection of the communication terminal 1 (account information) are stored in an account database (DB) 8a and managed by an account management server 8. The account information can be also updated, changed or deleted by the communication terminal 1 connected to the account management server 8 via a Web server 7. The Web server 7 also functions as a mail server sending emails and a file server downloading files.

The communication terminal 1a is connected to a microphone 3a, a camera 4a, a speaker 2a and a monitor 5a, and the videos imaged by the camera 4a and the audios collected by the microphone 3a are sent to the communication terminal 1b via the network 10. The communication terminal 1b is also connected to a microphone 3b, a camera 4b, a speaker 2b and a monitor 5b, and can similarly send the videos and the audios to the communication terminal 1a.

The videos and the audios received by the communication terminal 1b are outputted to the monitor 5b and the speaker 2b, and the videos and the audios received by the communication terminal 1a are outputted to the monitor 5a and the speaker 2a, respectively. It should be noted that the microphone 3 and the speaker 2 may be integrated as a headset.

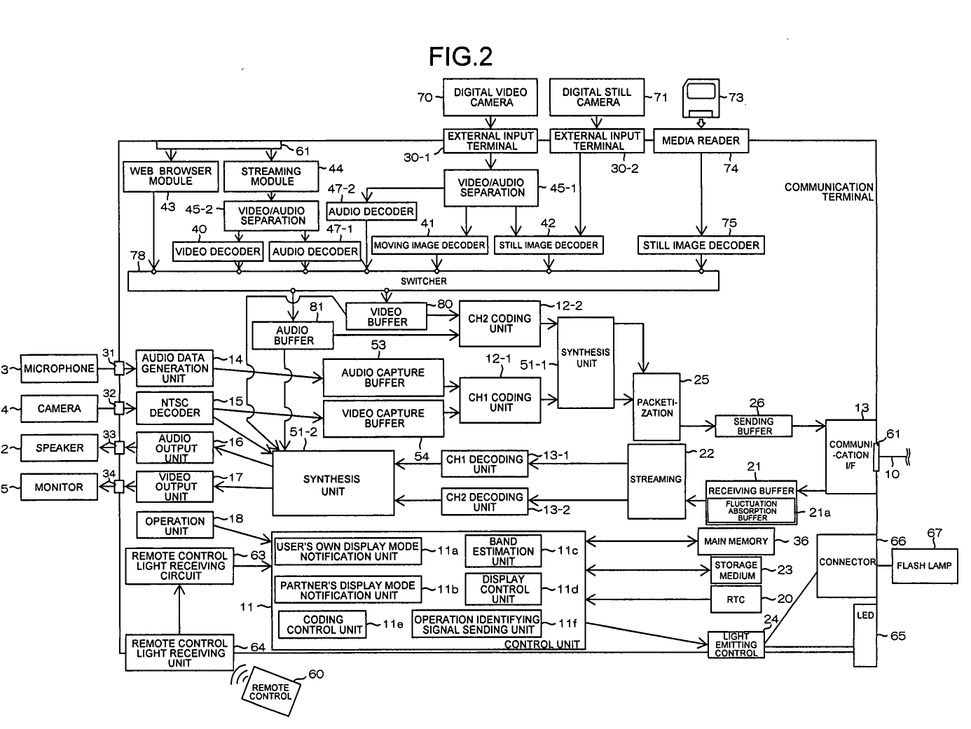

FIG. 2 is a block diagram showing a detailed configuration of the communication terminal 1.

An audio input terminal 31, a video input terminal 32, an audio output terminal 33 and a video output terminal 34 are provided on the outside of a body of the communication terminal 1, which are connected to the microphone 3, the camera 4, the speaker 2 and the monitor 5, respectively.

An external input terminal 30-1 is an input terminal based on IEEE 1394, and receives inputs of moving images, still images and audio data compliant to DV method or other specifications from a digital video camera 70. An external input terminal 30-2 receives inputs of still images compliant to JPEG specification or other specifications from a digital still camera 71.

An audio signal inputted into an audio data generation unit 14 from the microphone 3 connected to the audio input terminal 31 and a color difference signal generated by a NTSC decoder 15 are digitally compressed and coded by a CH1 coding unit 12-1 configured with a coder for high image quality such as an MPEG4 encoder, and then converted into stream data (content data in a real-time delivery enabled format). This stream data is referred to as CH1 stream data.

A video signal including any one of the still image or the moving image downloaded from a Web content server 90 by a Web browser module 43, which was set to be a data input source by a switcher 78, the still image or the moving image from the digital video camera 70, the still image or the moving image from the digital still camera 71, the moving image downloaded from a streaming server 91 by a streaming module 44, and the moving image or the still image from a recording medium 73 (hereinafter, these image input sources may be abbreviated as “video content input sources such as the digital video camera 70 and the like”), as well as an audio signal including the audio downloaded from the streaming server 91 by the streaming module 44, which was set to be the data input source by the switcher 78, or the audio from the digital video camera 70 (hereinafter, these audio input sources may be abbreviated as “audio input sources such as the digital video camera 70 and the like”) are digitally compressed and coded by a CH2 coding unit 12-2 configured with the coder for high image quality such as the MPEG4 encoder, and then converted into the stream data. This stream data is referred to as CH2 stream data.

The CH2 coding unit 12-2 has a function of converting the still image inputted from the digital video camera 70 and the like into the moving image and outputting it. Details of this function will be described later.

A synthesis unit 51-1 synthesizes the CH1 stream data and the CH2 stream data to create the stream data (synthesized stream data) and outputs it to a packetization unit 25.

The synthesized stream data is packetized by the packetization unit 25 and once stored in a sending buffer 26. The sending buffer 26 sends packets via a communication interface 13 to the network 10 at a certain timing. For example, when a moving image of 30 frames per second is captured, the sending buffer 26 has a capability of storing 1 frame of data in 1 packet and sending it.

It should be noted that this embodiment does not reduce a transmission frame rate, that is, skip frames, even if a transmission band of the network 10 is estimated to decrease, in order to prevent motion of the video from becoming stiff and not smooth.

A video/audio data separation unit 45-1 separates the video data and the audio data from multiplexed data inputted by the external input terminal 30-1.

Moving image data or still image data separated by the video/audio data separation unit 45-1 is decoded by a moving image decoder 41 or a still image decoder 42 respectively, and then temporarily stored as a frame image in a video buffer 80 at predetermined time intervals. It should be noted that the number of frames per second to be stored in the video buffer 80 (frame rate) has to match the frame rate of a video capture buffer 54 as described later (for example, 30 fps (frame per second)).

The audio data separated by the video/audio data separation unit 45-1 is decoded by an audio decoder 47-2, and then temporarily stored in an audio buffer 81.

The NTSC decoder 15 is a color decoder which converts a NTSC signal inputted by the camera 4 into a luminance signal and the color difference signal, and separates the NTSC signal into the luminance signal and a carrier chrominance signal with a Y/C separation circuit, and further demodulates the carrier chrominance signal with a chrominance signal demodulation circuit to generate the color difference signals (Cb, Cr).

The audio data generation unit 14 converts an analog audio signal inputted by the microphone 3 into digital data and outputs it to an audio capture buffer 53.

According to the control of a control unit 11, the switcher (switching circuit) 78 switches the image inputted into the video buffer 80 to any one of the moving image or the still image from the digital video camera 70, the still image from the digital still camera 71, and the moving image or the still image read from the recording medium 73 by a media reader 74.

A synthesis unit 51-2 synthesizes the video from the video content input sources such as the digital video camera 70 and the like and moving image frame images decoded by a CH1 decoding unit 13-1 and a CH2 decoding unit 13-2, and outputs this synthesized image to a video output unit 17. The synthesized image obtained in this way is displayed on the monitor 5.

At the partner's communication terminal 1, a streaming circuit 22 individually streams the video data coded by the CH1 coding unit 12-1 and the video data coded by the CH2 coding unit 12-2, and then the stream data coded by the CH1 coding unit 12-1 and the stream data coded by the CH2 coding unit 12-2 are decoded into the moving image or the audio, respectively at the CH1 decoding unit 13-1 and at the CH2 decoding unit 13-2, which are outputted to the synthesis unit 51-2.

The synthesis unit 51-2 resizes the video of the camera 4, that is, the use's own video, the moving image decoded by the CH1 decoding unit 13-1, that is, the partner's video, and the moving image decoded by the CH2 decoding unit 13-2, that is, video contents so that they may be included in display areas on a display screen of the monitor 5, and synthesizes them. The resizing is performed depending on a display mode switching inputted by a remote control 60.

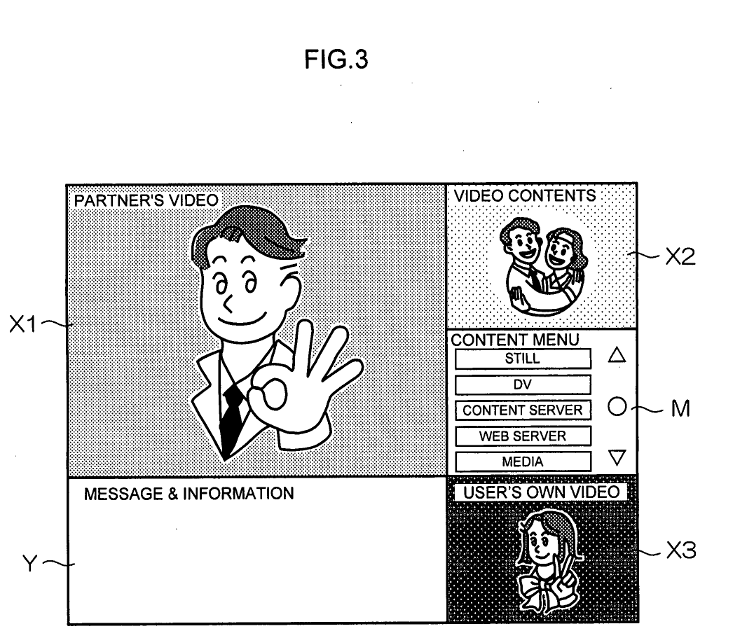

FIG. 3 shows an example of an arrangement of the videos displayed on the monitor 5. As shown in this figure, on the monitor 5, the video of the camera 4 at the partner's communication terminal 1 (partner's video) is displayed in a first display area X1, the video inputted by the video content input sources such as the digital video camera 70 and the like at the partner's communication terminal 1 (video contents) is displayed in a second display area X2, and the video inputted by the user's own camera 4 (user's own video) is displayed in a third display area X3.

The videos arranged in the first display area X1 to the third display area X3 are not limited to that shown in this figure, and they are switched depending on a setting of the display mode as described later.

In addition, a content menu M having a list of the video content input sources such as the digital video camera 70 and the like with respect to the user's own switcher 78 and other information, as well as a message and information display area Y for displaying various messages and notifications are reduced to be included in one screen, and displayed in non-overlapping areas respectively.

It should be noted that although this figure shows the respective display areas X1 to X3 divided and displayed in one display screen according to a predetermined area ratio, this screen division may be transformed in various ways. In addition, all of multiple videos do not necessarily have to be simultaneously displayed in one screen, and only the user's own video, only the partner's video or only the video contents, or a combination of some of them may be displayed, switching the display mode depending on a predetermined operation on the remote control 60. The display mode will be described later.

In the content menu M, an arbitrary item can be selected with the operation on the remote control 60. The control unit 11 controls to switch among the video content input sources with the switcher 78, depending on the item selection operation on the remote control 60. Thereby, the video to be displayed as the video contents can be arbitrarily selected. Here, Web contents obtained from the Web content server 90 by the Web browser module 43 become the video contents when “Web Server” item is selected. Streaming contents obtained from the streaming server 91 by the streaming module 44 become the video contents when “Content Server” item is selected. The video from the digital video camera 70 becomes the video contents when “DV” item is selected. The video from the digital still camera 71 becomes the video contents when “Still” item is selected. The video read from the recording media 73 becomes the video contents when “Media” item is selected.

The CH1 coding unit 12-1 sequentially compresses and codes captured audio data from the microphone 3 supplied by the audio capture buffer 53, according to an MPEG method and the like. The coded audio data is packetized by the packetization unit 25 and streamingly transmitted to the partner's communication terminal 1.

The CH2 coding unit 12-2 compresses and codes any one of the audio from the streaming module 44, which was set to be the audio input source by the switcher 78, and the audio from the digital video camera 70 (the audio input sources such as the digital video camera 70 and the like), according to the MPEG method and the like. The coded audio data is packetized by the packetization unit 25 and streamingly transmitted to the partner's communication terminal 1.

The CH1 decoding unit 13-1 decodes the audio data coded by the CH1 coding unit 12-1. The CH2 decoding unit 13-2 decodes the audio data coded by the CH2 coding unit 12-2.

The synthesis unit 51-2 synthesizes the audio data decoded by the CH1 decoding unit 13-1 and the audio data decoded by the CH2 decoding unit 13-2, and outputs this synthesized audio data to an audio output unit 16. In this way, the audio collected by the microphone 3 of the partner's communication terminal 1 and the audio obtained from the digital video camera 70 and the like connected to the partner's communication terminal 1 are played by the user's own speaker 2.

A band estimation unit 11c estimates the transmission band from jitter (fluctuation) of the network 10 and the like.

A coding control unit 1e changes video transmission bit rates of the CH1 coding unit 12-1 and the CH2 coding unit 12-2 depending on the estimated transmission band. In other words, the video transmission bit rates are decreased when the transmission band is estimated to decrease, and the video transmission bit rates are increased when the transmission band is estimated to increase. This can prevent packet loss from occurring due to packets sent beyond the transmission band, and enables a smooth stream data transmission depending on the change in the transmission band.

For example, the band estimation by the band estimation unit 11c may be specifically performed as follows. When a RTCP packet of SR (Sender Report) type (RTCP SR) is received from the partner's communication terminal 1b, a sequence number at a sequence number field in a header of the RTCP SR packet is counted to calculate the number of loss of the received RTCP SR. Then a RTCP packet of RR (Receiver Report) type (RTCP RR) having a description of the above described number of loss is sent to the partner's communication terminal 1. The RTCP RR also has a description of the time from receiving the RTCP SR until sending the RTCP RR (referred to as “response time”, for convenience only).

When the partner's communication terminal 1b receives the RTCP RR, RTT (Round Trip Time) is calculated, which is the time obtained by subtracting the response time from the time elapsed from the time of sending the RTCP SR until the time of receiving the RTCP RR. In addition, the number of sent packets of the RTCP SR and the number of loss of the RTCP RR are referred to, and (Number Of Loss)/(Number Of Sent Packets)=Packet Loss Rate in a periodic period is calculated. This RTT and the packet loss rate constitute a communication state report.

An appropriate interval for issuing a monitoring packet may be considered to be about once in 10 seconds or several tens of seconds. However, since a network state often cannot be correctly comprehended when estimated only in one monitoring packet attempt, an estimation accuracy is more improved by dividing the attempt into multiple attempts and taking their average and the like for the estimation. Since an increased number of monitoring packets itself may become a cause of narrowing the band, the number of the monitoring packets is preferably kept to 2 to 3% of total communication traffic.

In addition to the above description, it should be noted that the communication state report can be obtained by using various QoS (Quality of Service) control techniques to the band estimation unit 11c.

It should be noted that although a bit rate for coding the audio may be changed depending on the estimated transmission band, the bit rate may be fixed without problems since the transmission band of the audio has a lower contribution ratio to the band, compared to the video.

The packets of the stream data received from another communication terminal 1 via the communication interface 13 are once stored in a receiving buffer 21, and then outputted to the streaming device 22 at a certain timing. A fluctuation absorption buffer 21a in the receiving buffer 21 adds a delay to the time from receiving the packets until starting a playing, for a continuous playing even with the above described packets arriving at varied intervals due to their varied transmission delay times. The streaming device 22 reconfigures the packet data into stream playing data.

The CH1 decoding unit 13-1 and the CH2 decoding unit 13-2 are video and audio decoding devices configured with an MPEG4 decoder and the like.

A display control unit 11d controls the synthesis unit 51-2 depending on a screen switching signal inputted by the remote control 60, and then synthesizes and outputs (synthesized output) all or some of the video data decoded by the CH1 decoding unit 13-1 (CH1 video data), the video data decoded by the CH2 decoding unit 13-2 (CH2 video data), the video data inputted by the NTSC decoder 15 (user's own video), and the video data inputted by the video buffer 80 (video contents), or alternatively outputs any one of those video data without synthesizing it with other video data at all (through output). The video data outputted by the synthesis unit 51-2 is converted into the NTSC signal by the video output unit 17 and outputted to the monitor 5.

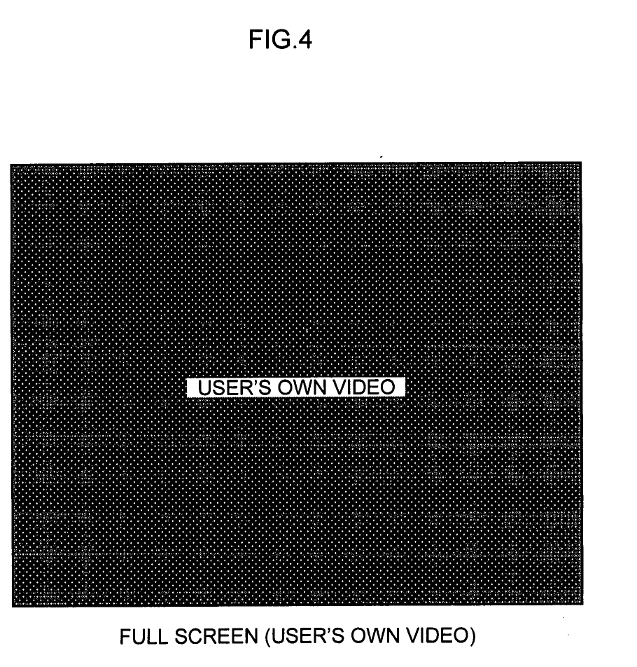

FIGS. 4 to 9 illustrate screens of the monitor 5 displaying the synthesized video data. The respective screens are sequentially switched with a display mode switching operation by the remote control 60.

FIG. 4 shows a screen display of the monitor 5 in the case where the synthesis unit 51-2 through-outputs only the video data from the camera 4 (user's own video) without synthesizing it with other video data, to the video output unit 17. At this screen, only the video imaged by the user's own camera 4 (user's own video) is displayed in full screen.

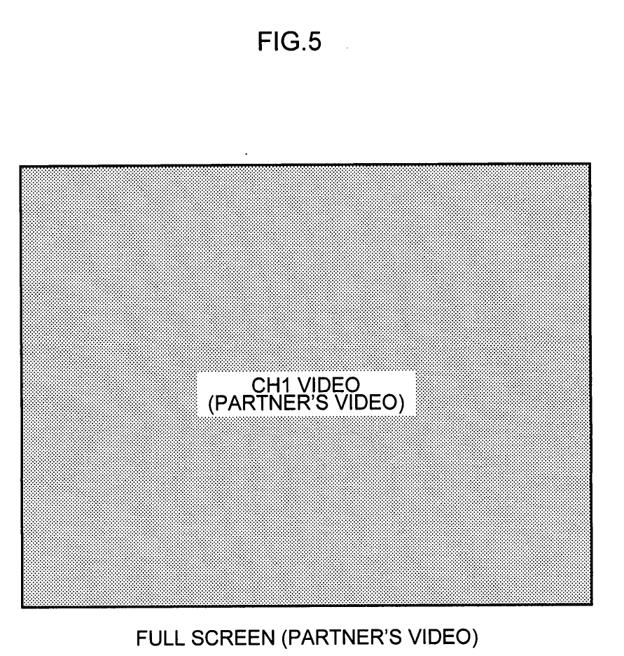

FIG. 5 shows a screen display of the monitor 5 in the case where the synthesis unit 51-2 through-outputs only the video data from the CH1 decoding unit 13-1 (partner's video) without synthesizing it with other video data, to the video output unit 17. At this screen, only the video imaged by the partner's camera 4 (partner's video) is displayed in full screen.

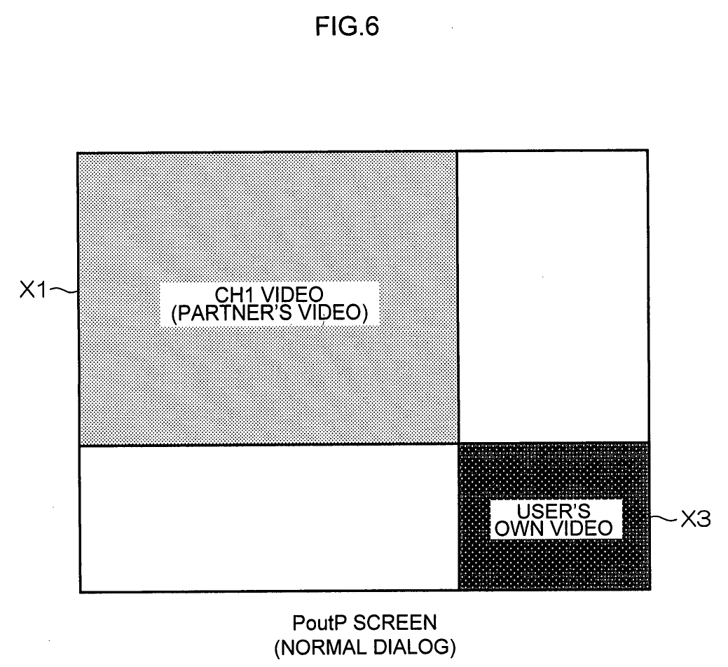

FIG. 6 shows a screen display of the monitor 5 in the case where the synthesis unit 51-2 synthesizes the video data from the CH1 decoding unit 13-1 (partner's video) and the video data from the user's own camera 4 (user's own video) and outputs them to the video output unit 17. At this screen, the partner's video and the user's own video are displayed in the display areas X1 and X3, respectively.

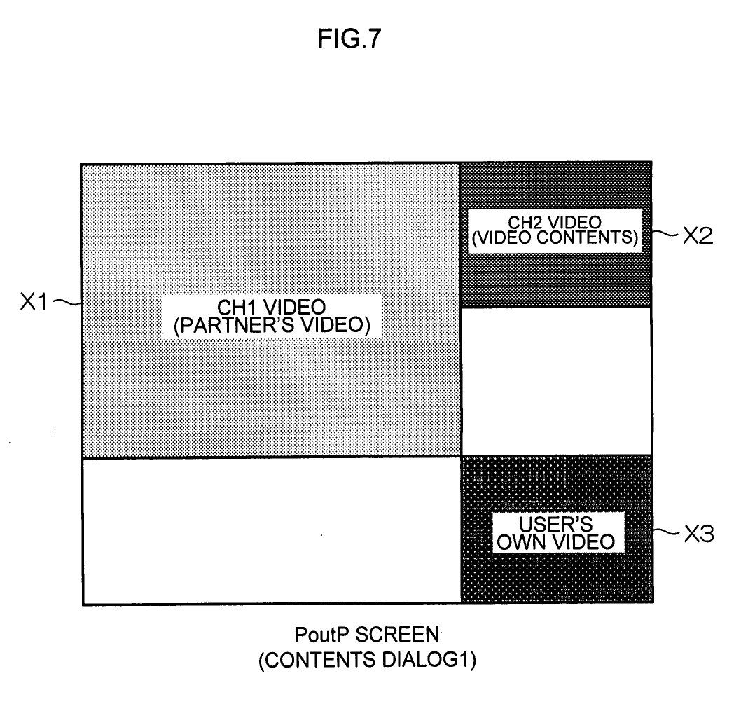

FIG. 7 shows a screen display of the monitor 5 in the case where the synthesis unit 51-2 synthesizes the video data from the CH1 decoding unit 13-1 (partner's video), the video data from the CH2 decoding unit 13-2 (video contents) and the video data from the user's own camera 4 (user's own video), and outputs them to the video output unit 17. At this screen, the partner's video, the video contents and the user's own video are resized so that they may be included in the display areas X1, X2 and X3, respectively, and displayed in the respective display areas. In addition, the display areas X1 and X3 keep a predetermined area ratio in which the display area X1 becomes larger than the display area X3.

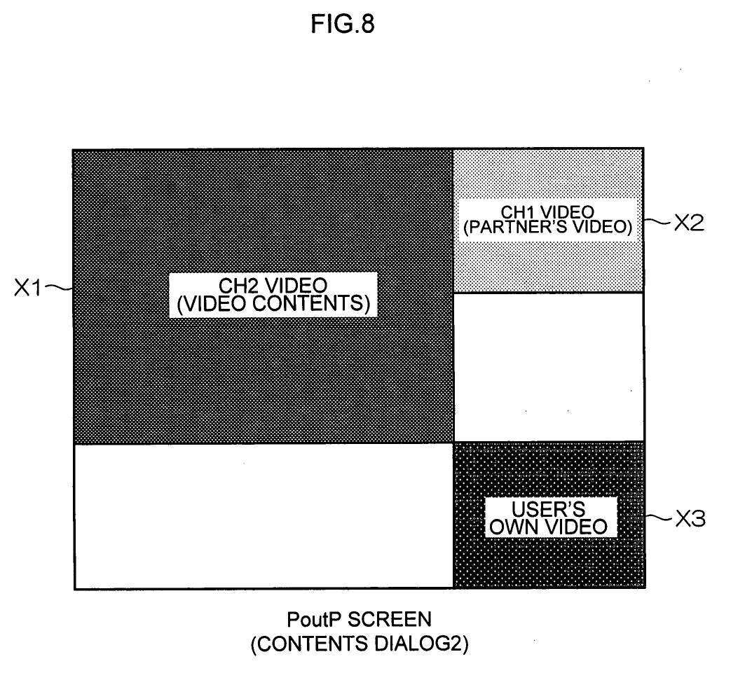

FIG. 8 shows a screen display of the monitor 5 in the case where the synthesis unit 51-2 synthesizes the video data from the CH1 decoding unit 13-1 (partner's video), the video data from the CH2 decoding unit 13-2 (video contents) and the video data from the user's own camera 4 (user's own video), and outputs them to the video output unit 17. At this screen, the video contents, the partner's video and the user's own video are displayed in the display areas X1, X2 and X3, respectively.

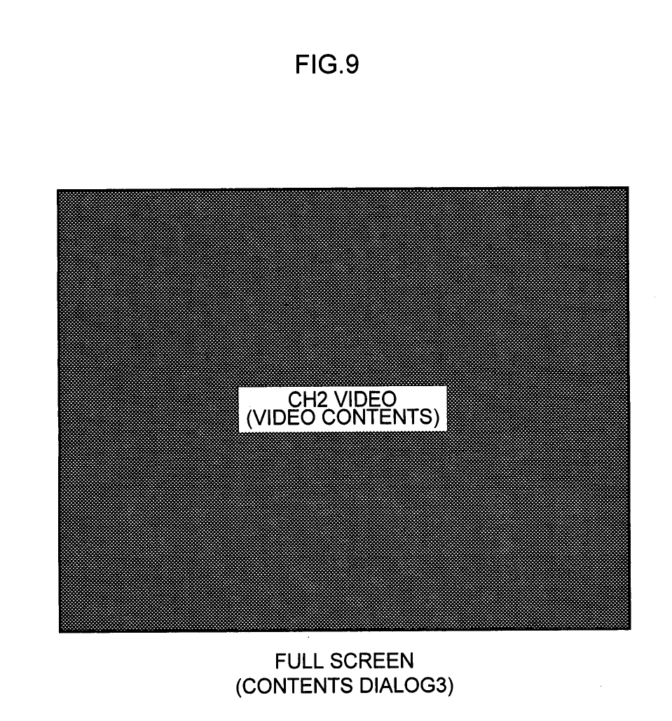

FIG. 9 shows a screen display of the monitor 5 in the case where the synthesis unit 51-2 through-outputs only the video data from the CH2 decoding unit 13-2 (video contents) without synthesizing it with other video data, to the video output unit 17. At this screen, only the video contents are displayed.

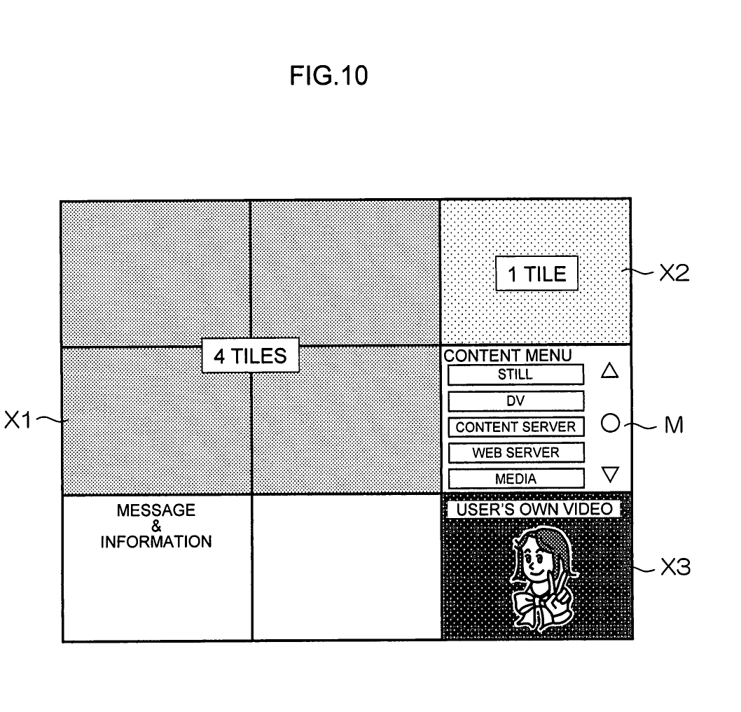

FIG. 10 shows an example of the area ratio of the respective display areas X1 to X3. In this figure, the screen having a screen area ratio of 4:3 is equally divided into 9 tiles, wherein the display area X1 has the area of 4 tiles while the display areas X2 and X3 have the areas of 1 tile. In addition, the content menu display area M has the area of 1 tile, and the message and information display area has the area of 2 tiles.

When the screen switching signal is inputted by the remote control 60, the communication terminal 1b sends a control packet showing that the screen switching signal has been inputted, to the communication terminal 1a via the network 10. The communication terminal 1a also has a similar function.

Depending on the area ratio of the display area X1, X2 or X3 identified with the control packet received from the partner's communication terminal 1, the coding control unit 11e assigns the transmission band of the video to be displayed in each of the display areas X1, X2 and X3 on the monitor 5 of the partner's communication terminal 1 (which is identifiable with the above described control packet) in the range of the estimated transmission band, and controls quantization circuits 117 for the CH1 coding unit 12-1 and the CH2 coding unit 12-2 so that the data may be included in the assigned transmission band (so that the packets may not overflow).

It should be noted that the audio data decoded by the CH1 decoding unit 13-1 and the CH2 decoding unit 13-2 is converted into the analog audio signal by the audio output unit 16 and outputted to the speaker 2. If necessary, also the audio data inputted by the user's own digital video camera 70 and the like and the audio data included in the content data can be synthesized by the synthesis unit 51-2 and outputted to the audio output unit 16.

The communication interface 13 is provided with a network terminal 61, which is connected to a broadband router or an ADSL modem and the like via various cables to connect to the network 10. One or more network terminals 61 are provided.

When the communication interface 13 is connected to a router having a firewall or a NAT function (Network Address Translation, which performs a mutual conversion between a global IP address and a private IP address), a problem is caused in which the communication terminals 1 cannot connect directly with each other with SIP (so called NAT Traversal), which has been recognized by those skilled in the art. In order to minimize the delay in a video and audio transmission by directly connecting the communication terminals 1 with each other, a STUN technique using a STUN (Simple Traversal of UDP through NATs) server 30 or a NAT Traversal function by an UPnP (Universal Plug and Play) server is preferably implemented on the communication terminals 1.

The control unit 11 totally controls the respective circuits in the communication terminal 1 based on the operations inputted by an operation unit 18 configured with various buttons or keys, or the remote control 60. The control unit 11 is configured with an arithmetic unit such as a CPU and the like, and realizes respective functions of the user's own display mode notification unit 11a, the partner's display mode detection unit 11b, the band estimation unit 11c, the display control unit 11d, the coding control unit 1e and an operation identifying signal sending unit 11f, with programs stored in a storage medium 23.

An address for uniquely identifying each communication terminal 1 (which is not necessarily synonymous with the global IP address), a password required by the account management server 8 for authenticating the communication terminal 1, and a launch program of the communication terminal 1 are stored in the nonvolatile storage medium 23 capable of retaining the data even in a power-off state. The programs stored in the storage medium 23 can be updated to their latest versions with update programs provided by the account management server 8.

The data required for various processes in the control unit 11 is stored in a main memory 36 configured with a RAM which temporarily stores the data.

The communication terminal 1 is provided with a remote control light receiving circuit 63, which is connected to a remote control light receiving unit 64. The remote control light receiving circuit 63 converts an infrared signal emitted from the remote control 60 to the remote control light receiving unit 64, into a digital signal, and outputs it to the control unit 11. The control unit 11 controls the respective operations depending on the digital infrared signal inputted by the remote control light receiving circuit 63.

A light emitting control circuit 24 controls light emitting, blinking and lighting of a LED 65 provided on the outside of the communication terminal 1, under the control of the control unit 11. A flash lamp 67 can be also connected to the light emitting control circuit 24 via a connector 66, and the light emitting control circuit 24 also controls light emitting, blinking and lighting of the flash lamp 67. An RTC 20 is a built-in clock.

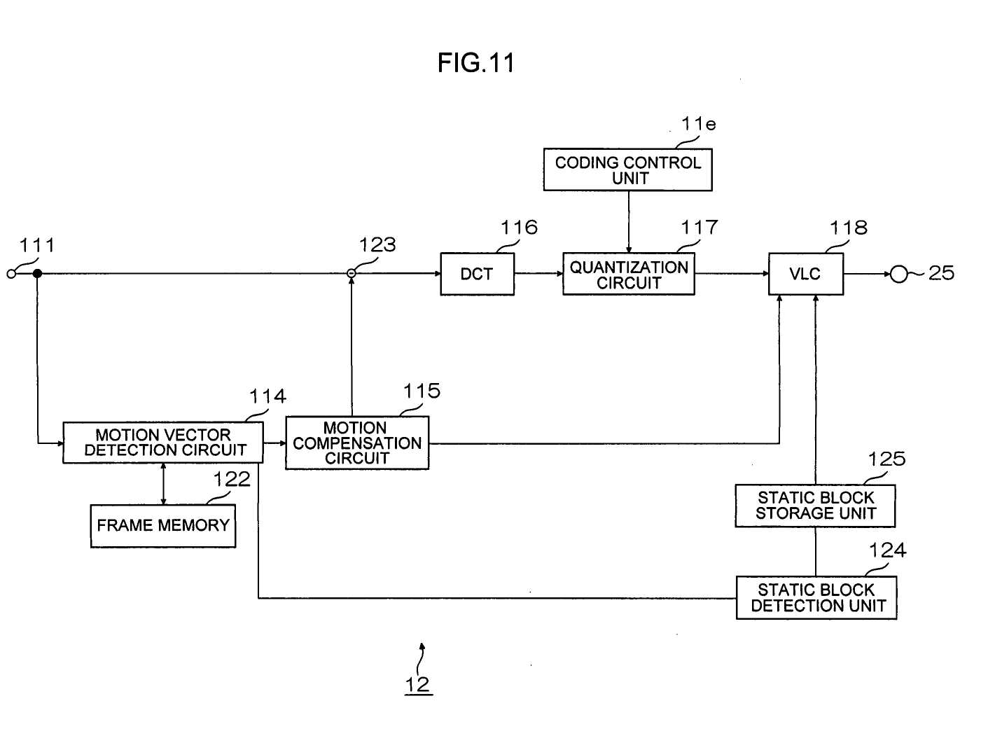

FIG. 11 is a block diagram showing a configuration of a substantial portion common to the CH1 coding unit 12-1 and the CH2 coding unit 12-2. The CH1 coding unit 12-1 and the CH2 coding unit 12-2 (which may be collectively represented as “coding unit 12”) include an image input unit 111, a motion vector detection circuit 114, a motion compensation circuit 115, a DCT 116, the quantization circuit 117, a variable length coding device (VLC) 118, the coding control unit 11e, a static block detection unit 124, a static block storage unit 125 and the like. This device partially includes a configuration of a video coding device of the MPEG method which combines a motion compensation predictive coding and a compressive coding with the DCT.

The image input unit 111 inputs the videos accumulated in the video capture buffer 54 or the video buffer 80 (only the moving image from the camera 4, only the moving image or the still image inputted by the digital video camera 70 and the like, or the moving image consisting of the synthesized image of those moving image and still image) into a frame memory 122.

The motion vector detection circuit 114 compares a current frame image represented by the data inputted by the image input unit 111 with a previous frame image stored in the frame memory 122 to detect a motion vector. This motion vector detection divides the inputted current frame image into multiple macro blocks, repeatedly calculates an error for each macro block while arbitrarily moving a macro block to be searched within each search range set on the previous frame image, to search a macro block which is most similar to the macro block to be searched (macro block having a minimum error) from within the search range, and determines a declination amount and a declination direction between the above described macro block and the macro block to be searched, to be the motion vector with respect to the macro block to be searched. Then, a motion vector having a minimum prediction difference in the predictive coding can be obtained, by synthesizing the motion vector obtained for each macro block in consideration of the error for each macro block.

The motion compensation circuit 115 performs a motion compensation with respect to a prediction reference image based on the detected motion vector to generate data on a prediction image, and outputs the data to a subtractor 123. The subtractor 123 subtracts the prediction image represented by the data inputted by the motion compensation circuit 115, from the current frame image represented by the data inputted by the image input unit 111, to generate difference data representing the prediction difference.

The DCT (Discrete Cosine Transform) unit 116, the quantization circuit 117 and the VLC 118 are sequentially connected to the subtractor 123. The DCT 116 orthogonally transforms the difference data inputted by the subtractor 123 for each arbitrary block and outputs it. The quantization circuit 117 quantizes the orthogonally transformed difference data inputted by the DCT 116 with a predetermined quantization step and outputs it to the VLC 118. Also, the motion compensation circuit 115 is connected to the VLC 118, and the motion compensation circuit 115 inputs data on the motion vector to the VLC 118.

The VLC 118 codes the orthogonally transformed and quantized difference data with two-dimensional Huffman coding, also codes the inputted motion vector data with Huffman coding, and then multiplexes both data. Then, the VLC 118 outputs variable-length coded moving image data at a rate defined based on a coding bit rate outputted by the coding control unit 1e. The variable-length coded moving image data is outputted to the packetization unit 25, and sent in packets as image compression information to the network 10. A code amount (bit rate) at the quantization circuit 117 is controlled by the coding control unit 1e.

A data structure of the coded moving image data created by the VLC 118 has a hierarchical structure, including a block layer, a macro block layer, a slice layer, a picture layer, a GOP layer and a sequence layer, from the bottom upwards.

The block layer consists of a DCT block which is a unit for performing the DCT. The macro block layer is configured with multiple DCT blocks. The slice layer is configured with a header section and one or more macro blocks. The picture layer is configured with a header section and one or more slice layers. A picture corresponds to one screen. The GOP layer is configured with a header section, an I picture which is a picture based on intra-frame coding, as well as P and B pictures which are pictures based on the predictive coding. The I picture can be decoded only with its own information, while the P and B pictures require a previous image or both of previous and subsequent images as the prediction image and are not decoded by themselves.

In addition, at the beginning of each of the sequence layer, the GOP layer, the picture layer, the slice layer and the macro block layer, an identification code consisting of each predetermined bit pattern is arranged, and a header section which stores coding parameters of each layer is arranged following the identification code.

The macro block included in the slice layer is an assembly of the multiple DCT blocks, in which the screen (picture) has been divided into grids (for example, 8 pixels*8 pixels). A slice is made by connecting these macro blocks in a horizontal direction, for example. When the size of the screen is determined, the number of the macro blocks for one screen is uniquely determined.

In an MPEG format, the slice layer is one variable-length code sequence. The variable-length code sequence is a sequence having data boundaries which cannot be detected without decoding a variable-length code. When decoding an MPEG stream, the header section of the slice layer is detected and a starting point and an end point are found in the variable-length code.

Here, if the image data inputted in the frame memory 122 includes only the still image, the motion vectors of all macro blocks become zero, and the data can be decoded only with the I picture. Then, it is not necessary to send the B and P pictures. Therefore, even if the transmission bandwidth of the network 10 becomes narrow, the still image can be relatively finely sent as the moving image to the partner's communication terminal 1.

In addition, even if the image data inputted in the frame memory 122 is the synthesized image of the still image and the moving image, the motion vector of the macro block corresponding to the still image becomes zero, and it is not necessary to send the data for its portion, regarding it as a skipped macro.

If the image data inputted in the frame memory 122 includes only the still image, the frame rate may be reduced and instead a code amount of the I picture may be increased. Thereby, a motionless still image can be finely displayed.

Even if a still image input source is switched by the switcher 78 at the user's own communication terminal 1a to any of the Web browser module 43, the digital video camera 70, the digital still camera 71 and the media reader 74, a frame moving image, in which the macro block of a portion corresponding to the still image becomes a zero motion vector, is sent to the partner's communication terminal 1b in real time independently of the type of the input source. Therefore, even if the still image input source is switched at random times by the switcher 78 at the user's own communication terminal 1a, following this switching, the frame moving image to be sent to the partner's communication terminal 1 is immediately switched, which, as a result, also immediately switches the still image to be displayed at the partner's communication terminal 1b.

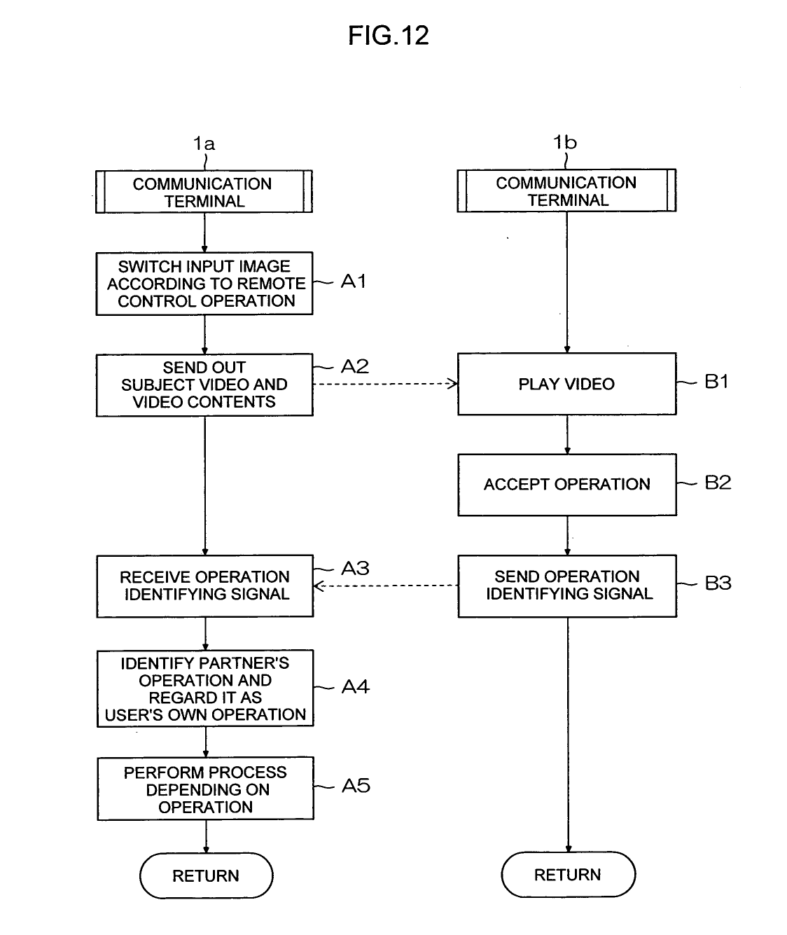

Next, according to a flowchart of FIG. 12, operations performed between the communication terminal 1a and the communication terminal 1b will be described.

First, at the communication terminal 1a, if the signal for selecting the video content input sources such as the digital video camera 70 and the like (input source selection signal) is inputted by the remote control 60, the control unit 11 controls the switcher (switching circuit) 78 according to this input source selection signal to switch the image to be inputted to the video buffer 80 (A1).

The communication terminal 1a codes the video contents supplied by the video content input source and a video of a subject supplied by the camera 4 respectively, and sends the packet data sequentially to the communication terminal 1b (A2). In addition, an operation state video showing the operation performed at the communication terminal 1a with respect to the video contents, for example, a video showing movement of a cursor or a mouse pointer may be created by an OSD circuit (not shown) and the like, and this operation state video may be synthesized with the video contents and sent out. This can display an operation state of the communication terminal 1a, at the communication terminal 1b.

As described above, it should be noted that the communication terminal 1a sends also the still image inputted by the digital still camera 71 and the like as the moving image in real time.

The communication terminal 1b streams the packets received from the communication terminal 1a, and then plays and displays one or both of the subject video and the video contents in the display area depending on the display mode set by the remote control 60, on the monitor 5b (B1).

The communication terminal 1b accepts the operation related to the video contents played and displayed on the monitor 5b, from the remote control 60 (B2). Specific examples of “operation related to the video contents” will be described later.

The operation identifying signal sending unit 11f of the communication terminal 1b sends the control packet for identifying the operation related to the video contents which has been inputted to the remote control 60 (operation identifying signal) to the communication terminal 1a (B3).

When the communication terminal 1a receives the operation identifying signal from the communication terminal 1b (A3), the communication terminal 1a identifies the operation related to the video contents which has been inputted to the communication terminal 1b, according to the received operation identifying signal (A4).

The communication terminal 1a performs a process depending on the identified operation related to the video contents (A5).

Now, “operation related to the video contents” and “process depending on the identified operation” can be illustratively listed for each video content input source as follows.

If the video content input source is the digital still camera 71 or the recording medium 73, “operation related to the video contents” includes: specifying the still image for which a print is ordered among the still images being currently played and displayed on the monitor 5b; specifying a command of requesting the communication terminal 1a to send an original image file itself of the above described still image being played and displayed from the communication terminal 1a to the communication terminal 1b; or specifying to arbitrarily switch the still image which the user hopes to play and display, among images stored in the digital still camera 71 or the recording medium 73 images, previously permitted to be browsed (for example, images in a folder in which only images permitted to be browsed are sorted therein, or images recorded in a DPOF format). “Process depending on the identified operation” includes: sending the still image specified as the still image for which the print is ordered, to a print shop 93; sending the original image file of the still image requested by the communication terminal 1b to be sent, to the communication terminal 1b; or streamingly transmitting the still image specified as the still image which the user hopes to play and display.

If the video content input source is the digital video camera 70, “operation related to the video contents” includes: specifying the video which the user hopes to play, among the video contents recorded in the digital video camera 70; specifying to start playing, end playing, fast-forward, rewind, suspend and cancel the suspension of the video contents being currently played; or specifying a command of requesting the communication terminal 1a to send an original image file itself of the above described moving image being played and displayed from the communication terminal 1a to the communication terminal 1b. “Process depending on the identified operation” includes: starting and ending the streaming transmission of the video contents, fast-forwarding the video, rewinding the video, suspending the video and canceling the suspension of the video, depending on the specification; or sending the original image file of the moving image requested by the communication terminal 1b to be sent, to the communication terminal 1b.

If the video content input source is the Web content server 90, “operation related to the video contents” includes: specifying to vertically and horizontally scroll, scale and move the Web page being currently displayed; specifying to jump to a hyperlink destination embedded in the Web page being currently displayed; or specifying to input information to various input form such as a product purchase form and send the inputted information to the Web content server 90. “Process depending on the identified operation” includes downloading necessary Web contents and uploading necessary data, depending on the specification.

If the video content input source is the streaming server 91, “operation related to the video contents” includes: specifying to fast-forward, rewind, suspend and restart playing the video contents being currently played. “Process depending on the identified operation” includes: starting and ending of downloading the stream of the video contents, playing, fast-forwarding, rewinding, suspending and canceling the suspension of the downloaded video, depending on the specification.

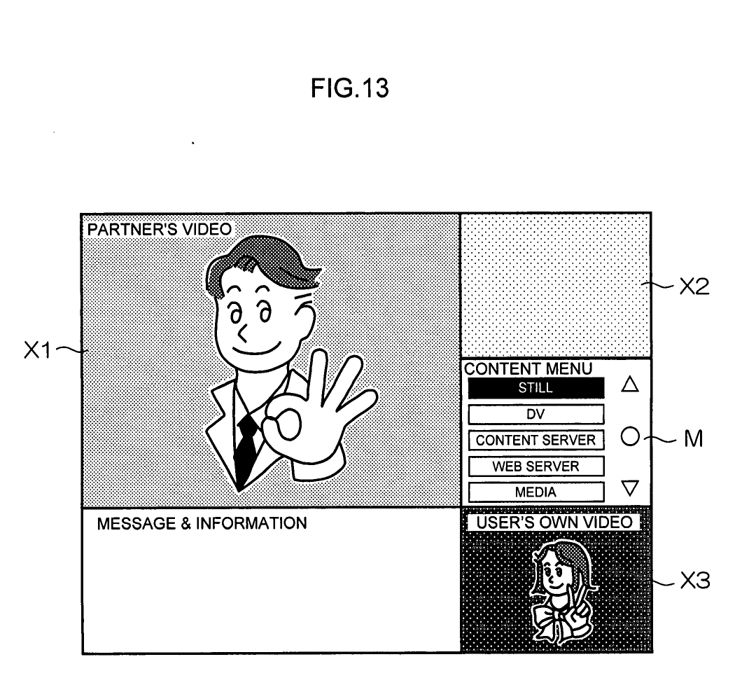

These operations may be illustrated in figures as follows. For example, it is assumed that, at the communication terminal 1a, “Still”, that is, the digital still camera 71 has been selected as the video content input source from the content menu display area M on the monitor 5a (FIG. 13). In this case, a list of file names of still image files stored in the digital still camera 71 is displayed in the content menu display area M on the monitor 5b (not shown).

If a desired image file name is selected from this list with the operation on the remote control 60 at the communication terminal 1b, the operation identifying signal showing the selected file name is sent to the communication terminal 1a. When the communication terminal 1a receives the operation identifying signal, according to the operation identifying signal, the communication terminal 1a identifies the file name selected by the communication terminal 1b and the still image file given the above described file name in the digital still camera 71, and streamingly transmits the still image recorded in this still image file as the moving image.

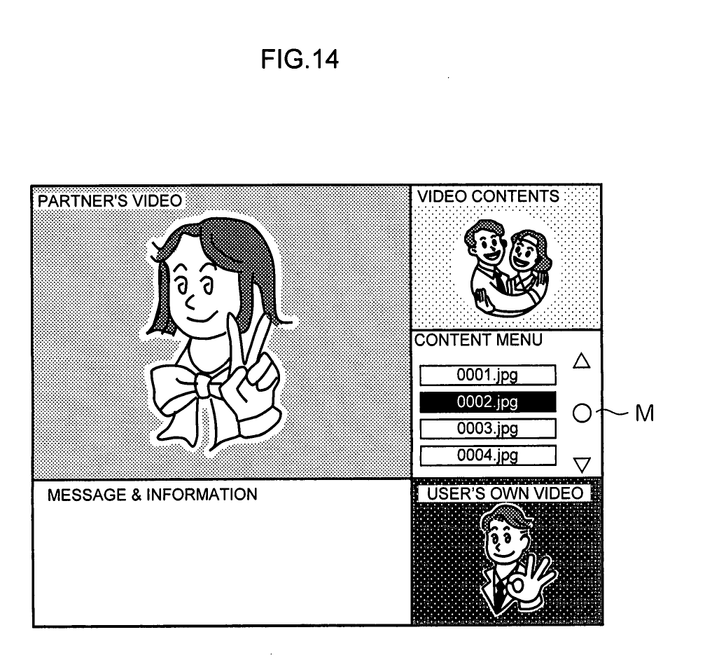

On the monitor at the communication terminal 1b, a stream moving image of the still image selected from the content menu display area M is displayed as the video contents, and the subject imaged by the partner's camera 4a (partner's video) as well as the subject imaged by the user's own camera 4b (user's own video) are also displayed (FIG. 14).

If the user likes the displayed still image, the communication terminal 1b can request the communication terminal 1a to send a print order or an album creation request to the print shop 93, and also the communication terminal 1b can send a command of requesting the communication terminal 1a to send the still image file itself instead of the stream moving image.

Since the user can simultaneously browse the same still image with a partner user while communicating with each other via the videos and the audios, it is possible for remote interested parties to interact with respect to the same image in real time, or to decide the image for which the print should be ordered.

However, since it is inconvenient to accept the print order or the album creation request without restriction, an order instruction may be sent to the print shop 93 only if a permission has been inputted with the operation on the remote control 60 at the communication terminal 1a and the like.

In addition, since it may cause a problem when every image in the digital still camera 71 is freely browsed, the stream moving image of the still image selected from the content menu display area M at the communication terminal 1b may be sent only if the permission has been inputted with the operation on the remote control 60 at the communication terminal 1a and the like.

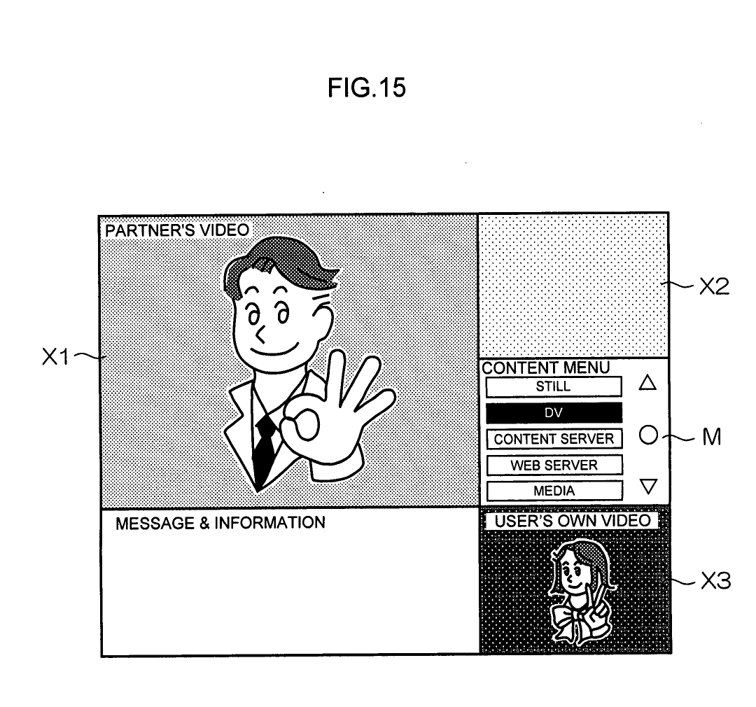

Alternatively, for example, it is assumed that, at the communication terminal 1a, “DV”, that is, the digital video camera 70 has been selected as the video content input source from the content display area M on the monitor 5a (FIG. 15). In this case, a list of file names of moving image files stored in the digital video camera 70 is displayed in the content menu display area M on the monitor 5b (not shown).

If a desired image file name is selected from this list with the operation on the remote control 60 at the communication terminal 1b, the operation identifying signal showing the selected file name is sent to the communication terminal 1a. When the communication terminal 1a receives the operation identifying signal, according to the operation identifying signal, the communication terminal 1a identifies the file name selected by the communication terminal 1b and the moving image file given the above described file name, and streamingly transmits the moving image recorded in this moving image file.

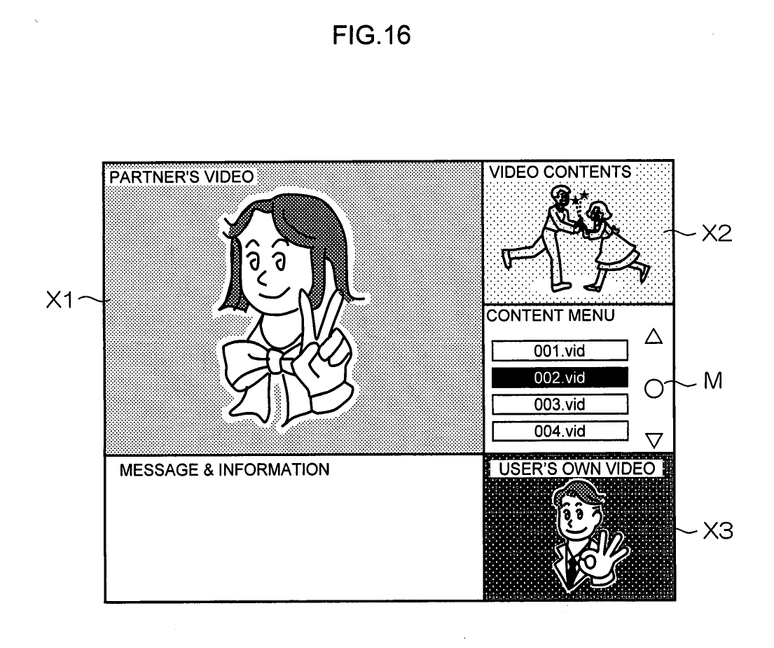

On the monitor 5b at the communication terminal 1b, the selected moving image is displayed as the video contents, and the subject imaged by the partner's camera 4a is also displayed (FIG. 16).

Also in this case, since the user can simultaneously browse the same moving image file with the partner user while communicating with each other via the videos and the audios, it is possible for the remote interested parties to interact with respect to the same moving image in real time.

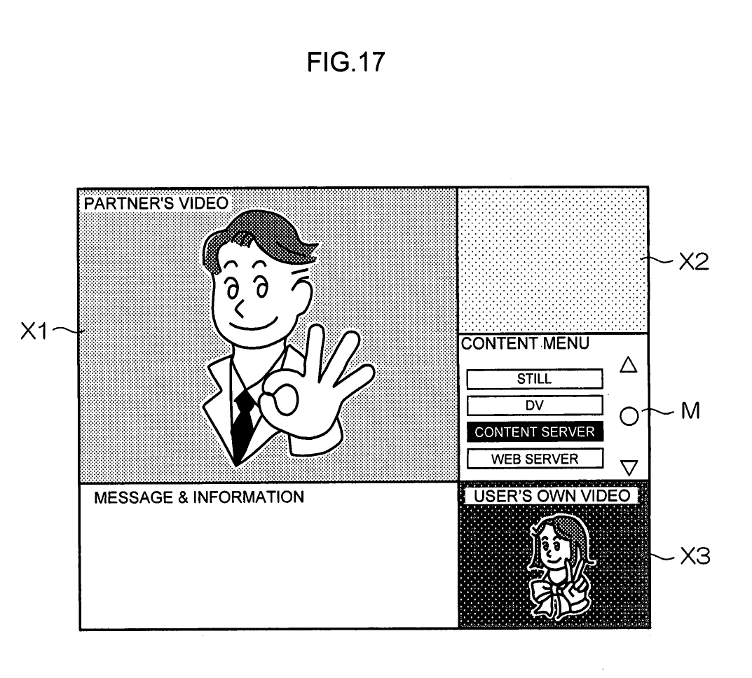

Alternatively, for example, it is assumed that, at the communication terminal 1a, “Content Server”, that is, the streaming server 91 has been selected as the video content input source from the content display area M on the monitor 5a (FIG. 17). In this case, a list of content names of moving image contents stored in the streaming server 91 is displayed in the content menu display area M on the monitor 5b (not shown).

If a desired content name is selected from this list with the operation on the remote control 60 at the communication terminal 1b, the operation identifying signal showing the selected content name is sent to the communication terminal 1a. When the communication terminal 1a receives the operation identifying signal, according to the operation identifying signal, the communication terminal 1a identifies the content name selected by the communication terminal 1b and the moving image contents given the above described content name, downloads this moving image contents from the streaming server 91, and then streamingly transmits this downloaded moving image. Since the data from the streaming server 91 is sent via the communication terminal 1a to the communication terminal 1b, the streaming server 91 does not have to send the data to the communication terminal 1b, and therefore the load on the streaming server 91 is not increased.

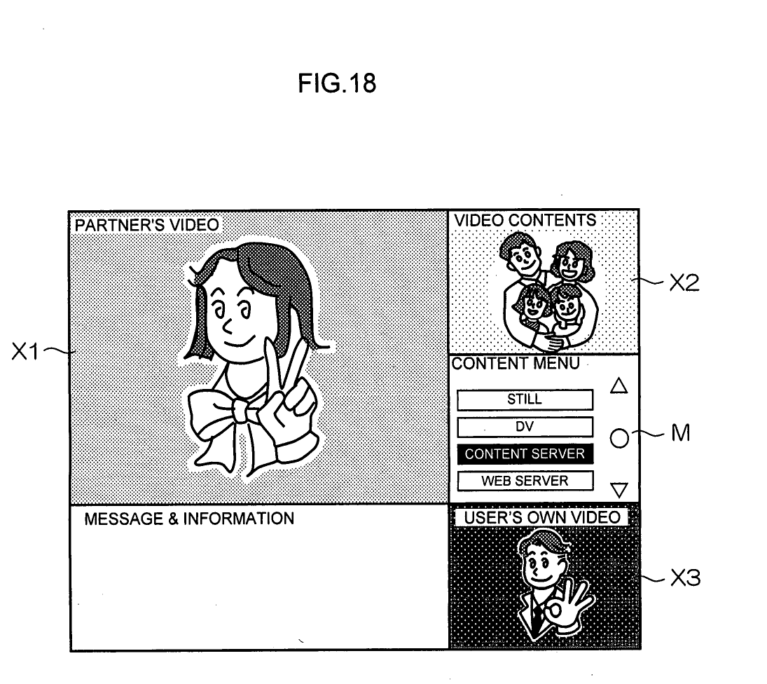

On the monitor at the communication terminal 1b, the selected moving image is displayed as the video contents, and the subject imaged by the partner's camera 4a is also displayed (FIG. 18).

Also in this case, since the user can simultaneously browse the same moving image contents with the partner user while communicating with each other via the videos and the audios, it is possible for the remote interested parties to interact with respect to the same moving image in real time.

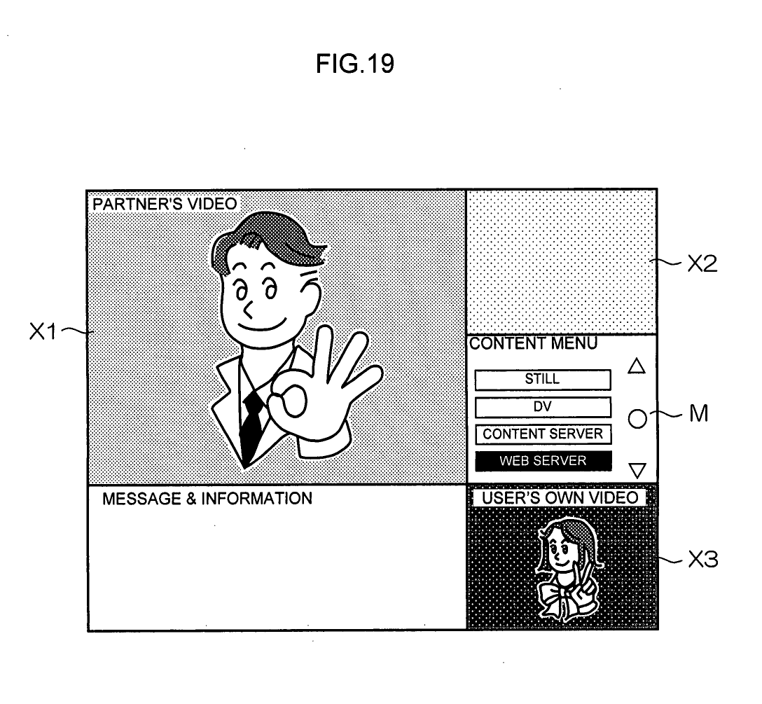

Alternatively, for example, it is assumed that, at the communication terminal 1a, “Web Server”, that is, the Web content server 90 has been selected as the video content input source from the content display area M on the monitor 5a (FIG. 19). In this case, a list of content names of Web contents (for example, Web pages) stored in the Web content server 90 is displayed in the content menu display area M on the monitor 5b (not shown).

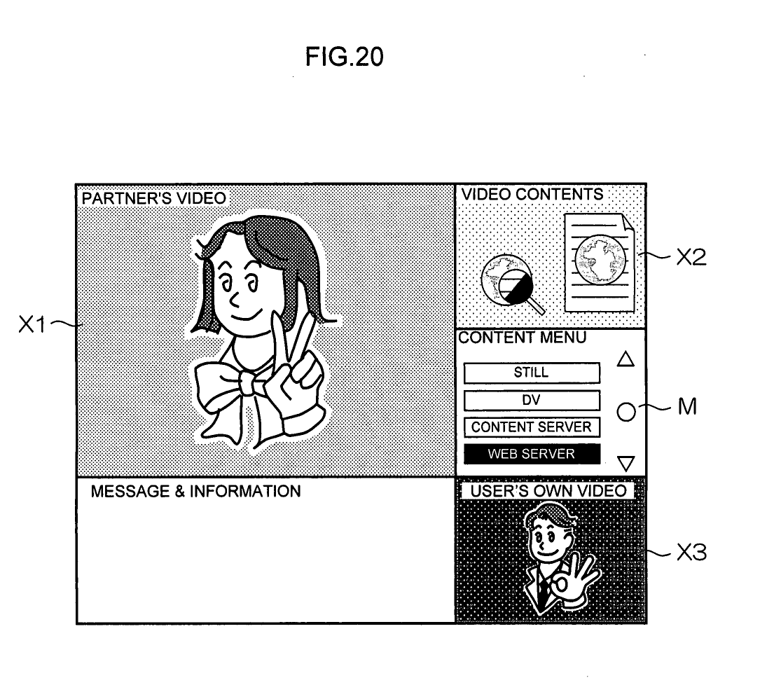

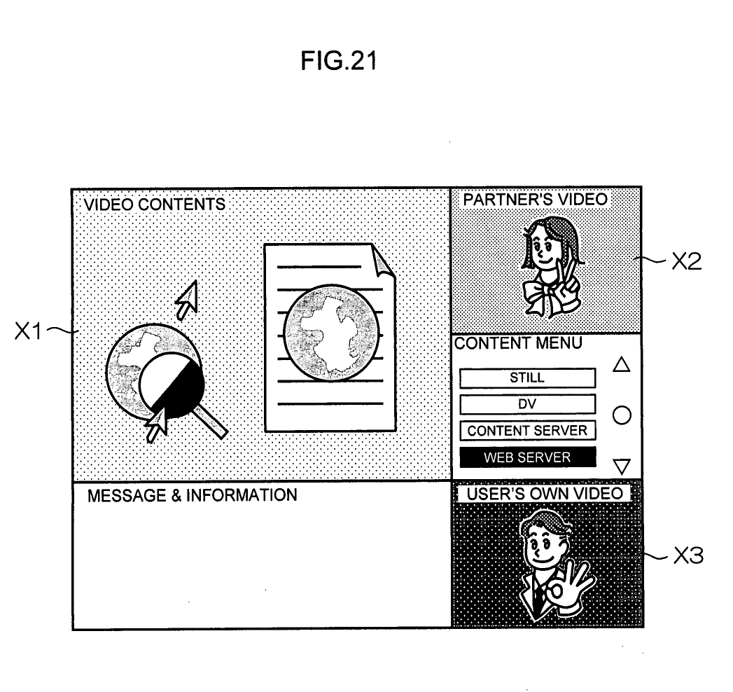

If a desired content name is selected from this list with the operation on the remote control 60 at the communication terminal 1b, the operation identifying signal showing the selected content name is sent to the communication terminal 1a. When the communication terminal 1a receives the operation identifying signal, according to the operation identifying signal, the communication terminal 1a identifies the content name selected by the communication terminal 1b and the contents given the above described content name, downloads this Web contents from the Web content server 90, and then streamingly transmits this downloaded Web contents as the moving image. On the monitor at the communication terminal 1b, the selected Web contents are displayed as the video contents, and the subject imaged by the partner's camera 4a is also displayed (FIG. 20). Depending on the display mode switching by the remote control 60, a display position of the Web contents may be set in the display area X1, and the partner's subject image may be displayed in the display area X2 (FIG. 21).

In addition, the communication terminal 1b may synthesize the video showing the operation state inputted by the user's own remote control 60 and the like (pointer and the like) with the video received from the communication terminal 1a and display them (FIG. 21). This makes the user's own operation state with respect to the video received from the partner more understandable at the communication terminal 1b.

However, since it may be inconvenient when the information to the input form specified by the communication terminal 1a is sent to the communication terminal 1b, the Web contents may be streamingly transmitted only if the permission has been inputted with the operation on the remote control 60 at the communication terminal 1a and the like.

Also, since it is inconvenient to accept accesses to the Web contents without restriction, the Web contents may be streamingly transmitted only if the permission has been inputted with the operation on the remote control 60 at the communication terminal 1a and the like.

In either case, since the user can simultaneously browse the same Web contents with the partner user while communicating with each other via the videos and the audios, also in this case, it is possible for the remote interested parties to interact with respect to the same Web contents in real time.

What is claimed is:

1. A communication system comprising:
a sender terminal which sends a subject video and video contents, and
a receiver terminal which receives the subject video and the video contents from the sender terminal and displays the subject video and the video contents on a screen, wherein
the receiver terminal comprises a receiver operation unit which accepts various input operations related to the video contents displayed on the screen, and an operation identifying signal sending unit which sends an operation identifying signal that is a signal for identifying an operation related to the video contents which has been inputted to the receiver operation unit, to the sender terminal; and
the sender terminal comprises an operation identifying signal receiving unit which receives the operation identifying signal, and a sender operation unit which identifies the operation related to the video contents in the receiver terminal according to the operation identifying signal received by the operation identifying signal receiving unit and regards the identified operation in the receiver terminal as the input operation.

2. The communication system according to claim 1, wherein the receiver terminal synthesizes the video contents and a video showing the input operation related to the video contents which has been accepted by the receiver operation unit, and displays the synthesized video contents and video on the screen.

3. The communication system according to claim 1, wherein the sender terminal displays a list of one or more video content input systems on the screen, and sends the video contents of the input system arbitrarily specified from the list of the video content input systems displayed on the screen according to the input operation with respect to the sender operation unit, to the receiver terminal.

4. The communication system according to claim 2, wherein the sender terminal displays a list of one or more video content input systems on the screen, and sends the video contents of the input system arbitrarily specified from the list of the video content input systems displayed on the screen according to the input operation with respect to the sender operation unit, to the receiver terminal.

5. The communication system according to claim 1, wherein the one or more video content input systems include a content server, a Web server, an information reading device for a portable recording medium, a still camera, a video camera, or a combination of some or all of the content server, the Web server, the information reading device for the portable recording medium, the still camera and the video camera.

6. The communication system according to claim 2, wherein the one or more video content input systems include a content server, a Web server, an information reading device for a portable recording medium, a still camera, a video camera, or a combination of some or all of the content server, the Web server, the information reading device for the portable recording medium, the still camera and the video camera.

7. The communication system according to claim 3, wherein the one or more video content input systems include a content server, a Web server, an information reading device for a portable recording medium, a still camera, a video camera, or a combination of some or all of the content server, the Web server, the information reading device for the portable recording medium, the still camera and the video camera.

8. The communication system according to claim 4, wherein the one or more video content input systems include a content server, a Web server, an information reading device for a portable recording medium, a still camera, a video camera, or a combination of some or all of the content server, the Web server, the information reading device for the portable recording medium, the still camera and the video camera.

9. The communication system according to claim 1, wherein the various input operations related to the video contents include specifying an image for which a print is ordered, specifying a video to be played, and requesting to download original data of video content data.

10. The communication system according to claim 2, wherein the various input operations related to the video contents include specifying an image for which a print is ordered, specifying a video to be played, and requesting to download original data of video content data.

11. The communication system according to claim 3, wherein the various input operations related to the video contents include specifying an image for which a print is ordered, specifying a video to be played, and requesting to download original data of video content data.

12. The communication system according to claim 4, wherein the various input operations related to the video contents include specifying an image for which a print is ordered, specifying a video to be played, and requesting to download original data of video content data.

13. The communication system according to claim 5, wherein the various input operations related to the video contents include specifying an image for which a print is ordered, specifying a video to be played, and requesting to download original data of video content data.

14. The communication system according to claim 6, wherein the various input operations related to the video contents include specifying an image for which a print is ordered, specifying a video to be played, and requesting to download original data of video content data.

15. The communication system according to claim 7, wherein the various input operations related to the video contents include specifying an image for which a print is ordered, specifying a video to be played, and requesting to download original data of video content data.

16. The communication system according to claim 8, wherein the various input operations related to the video contents include specifying an image for which a print is ordered, specifying a video to be played, and requesting to download original data of video content data.

17. A communication terminal which sends a subject video and video contents to a partner's communication terminal, comprising:
an operation identifying signal receiving unit which receives an operation identifying signal that is a signal for identifying an operation related to the video contents which has been inputted to the partner's communication terminal, from the partner's communication terminal; and
a sender operation unit which identifies the operation related to the video contents in the partner's communication terminal according to the operation identifying signal received by the operation identifying signal receiving unit and regards the identified operation in the partner's communication terminal as an input operation.

18. A communication terminal which receives a subject video and video contents from a partner's communication terminal and displays the subject video and the video contents on a screen, comprising:
an operation identifying signal sending unit which sends an operation identifying signal that is a signal for identifying an operation related to the video contents displayed on the screen, to the partner's communication terminal.

19. A communication method used in a communication system comprising a sender terminal which sends a subject video and video contents, and a receiver terminal which receives the subject video and the video contents from the sender terminal and displays the subject video and the video contents on a screen, the method comprising the steps of:
accepting an input operation related to the video contents displayed on the screen of the receiver terminal;
sending an operation identifying signal that is a signal for identifying the accepted operation related to the video contents;
receiving the operation identifying signal; and
identifying the operation related to the video contents in the receiver terminal according to the received operation identifying signal and regarding the identified operation in the receiver terminal as the input operation in the sender terminal.
